(19) United States
(12) Patent Application Publication
(10) Pub. No.: US 2006/0011212 A1
(43) Pub. Date: Jan. 19, 2006

(54) Manual advance dental floss holder

(75) Inventors: H. Allen Achepohl, Western Springs, IL (US); Cunjiang Cheng, Milwaukee, WI (US); Richard S. Demke, Homer Glen, IL (US); Lawrence Fenske, Madison, WI (US); Russell Glen Kalbfeld, Naperville, IL (US); Chad E. Misner, Arlington Heights, IL (US); Randy Soibel, Chicago, IL (US); Evan Sparks, Madison, WI (US); Thomas Studney, River Forest, IL (US); Kristin Noelle Vitek, Chicago, IL (US); Andrew P. Wilke, Madison, WI (US); Kevin Yost, Winnetka, IL (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Sunstar Americas, Inc., Chicago, IL (US)

(21) Appl. No.: 11/200,977

(22) Filed: Aug. 10, 2005

Related U.S. Application Data
(63) Continuation-in-part of application No. 10/145,464, filed on May 14, 2002.
(60) Provisional application No. 60/600,395, filed on Aug. 10, 2004.

(51) Int. Cl. A61C 15/00

(52) U.S. Cl. 132/325

(57) ABSTRACT

A manual advance floss holder which is simple and inexpensive to construct, comfortable to grasp, convenient to use in one hand and presents floss for flossing under uniform and proper tension while protecting the supply of unused floss from contamination including a body with a fork located at its distal end, a floss control mechanism within the body of the manual advance floss holder, a floss control mechanism including supply and take-up reels and means for advancing the floss therebetween under tension, and different compartments within the body for isolating spent and fresh floss.

### CROSS-REFERENCE TO RELATED PATENT APPLICATIONS

This patent application claims the benefit of U.S. Provisional Patent Application No. 60/600,395, filed Aug. 10, 2004, the disclosure of which is hereby incorporated in its entirety by reference.

### BACKGROUND OF THE INVENTION

This invention relates generally to devices for holding dental floss, and, more particularly, to an improved device for holding a protected supply of dental floss, presenting a tensioned portion of the floss for use in flossing, and advancing the floss through the device to provide a fresh portion of floss as needed.

Traditionally, dental floss is used by grasping the ends of a length of floss and reciprocating the floss back and forth in the spaces between the teeth. Dental floss is usually supplied for this purpose in small spools from which lengths of floss are cut off as needed, wrapped around the fingers of the user's hands, and manually held under tension as the floss is reciprocated back and forth in the spaces between the teeth.

In order to ensure a good grip on such manually-grasped floss, the ends of the floss must be securely wrapped around the user's fingers. This is often uncomfortable, particularly as the flossing operation proceeds and the floss cuts into the user's fingers. Also, in order to ensure that the floss does not come loose from the user's fingers, it is necessary to include a leader of at least several inches at either end of the length of floss being used, so that this leader can be turned around the user's fingers at least several times. This leader is not used in the actual flossing in the spaces between the teeth and is therefore wasted. Finally, the entire length of floss is vulnerable to contamination by bacteria on the user's hand and in the surrounding environment to which the floss is exposed.

Floss holders which hold a supply of floss, eliminate the wasted leader and the discomfort of traditional flossing techniques, and can be held in one hand while passing an exposed portion of the floss between the user's teeth are known. There are myriad such devices with a variety of different mechanisms for supporting the exposed portion of the floss which is to be reciprocated back and forth in the spaces between the teeth and for advancing the floss through the device, as it is spent. All such devices are complex in their design and operation.

It is therefore an object of the present invention to provide a floss holder which may be conveniently grasped in one hand and manually operated, and which is simple and straightforward in its construction and operation. The present new and improved floss holder is simple and inexpensive to construct, particularly comfortable to grasp, and convenient to use single-handedly. It holds the portion of floss presented for flossing under uniform and proper tension and it protects the supply of unused floss from contamination.

### BRIEF DESCRIPTION OF THE DRAWINGS

The features of this invention which are believed to be novel are set forth with particularity in the appended claims. The invention, together with its objects and advantages, may be best understood by reference to the following description, taken in conjunction with the following drawings, in which like reference numbers identify like elements in the several figures and in which:

FIG. 1 is a perspective view of a floss holder in accordance with the present invention, highlighting the prongs holding an exposed portion of floss;

FIG. 2 is a front elevation view of the floss holder of FIG. 1;

FIG. 3 is a side elevation view of the floss holder of FIG. 1;

FIG. 4 is an elevation view of the floss holder of FIG. 1, with the cover of the holder separated from the bottom, exposing a portion of the internal mechanism of the device;

FIGS. 5A and 5B are, respectively, cut-away front elevation views of the floss holder of FIG. 1 showing the floss control mechanism of the device in the absence of floss (FIG. 5A) and with floss supplied to the floss control mechanism (FIG. 5B);

FIG. 6A is a top plan view of the inside of the cover of a floss holder in accordance with FIG. 1;

FIG. 7 is a top plan view of the inside of the base of a floss holder in accordance with FIG. 1;

FIG. 8 is a perspective view of the knurled dial of the floss holder from the ratchet wheel side, including the spring metal ratchet finger plate showing fingers of the plate resting against ratchet teeth;

FIG. 9 is an enlarged partial perspective view of several ratchet teeth of the ratchet wheel of FIG. 8 showing the contour of the ratchet teeth and a spring metal ratchet finger resting upon one of the teeth;

FIG. 10 is a perspective view of a spool of floss from the floss holder of FIG. 1;

FIG. 11 is a top plan view of the spring plate of the floss holder of FIG. 1 showing the fingers of the plate that engage sprocket teeth on the floss spool;

FIG. 12 is an enlarged partial perspective view of the head of the floss holder of FIG. 1 showing the prongs of the device, as well as a groove in the outer edge of one of the prongs which receives floss from an opening in the floss holder through which the floss passes;

FIG. 13 is a cut-away side elevation view of the floss holder of FIG. 1 taken along lines 13-13 of FIG. 2 showing the knurled dial and the floss spool mounted in the device; and

FIG. 14 is a perspective view of a floss holder in accordance with FIG. 1 resting in an upright position in a receptacle designed to be disposed on a horizontal surface.

### DETAILED DESCRIPTION OF A PREFERRED EMBODIMENT

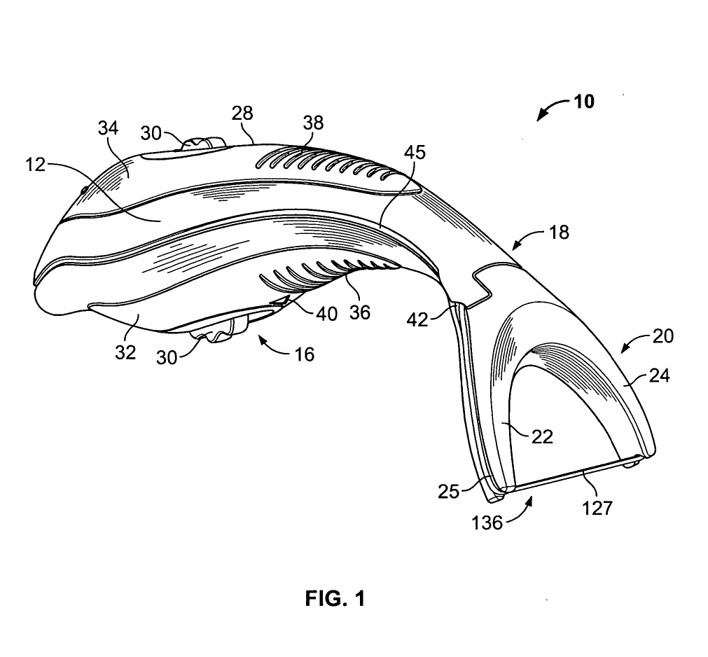

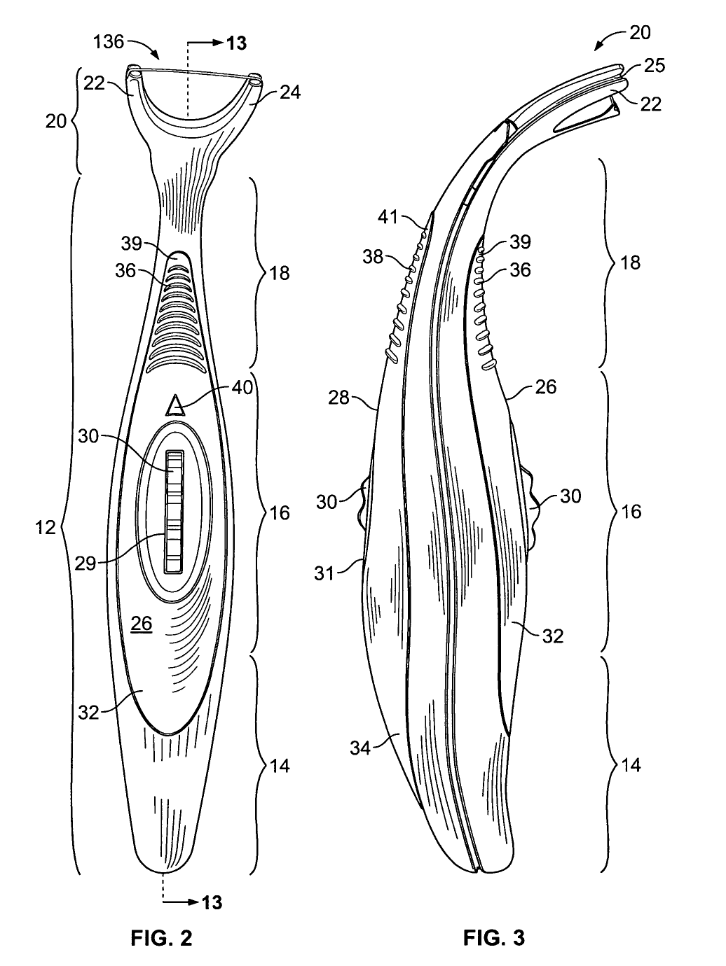

Turning to FIGS. 1-3, floss holder 10 in accordance with the present invention is shown including a body 12 having a tapered end 14, a bulbous gripping portion 16, and a tapered neck 18. A fork 20, which is located at the distal end of the body, includes generally distally directed spaced apart tines 22 and 24. The front of the body of the floss holder is designated by the number 26 and the back of the body of the floss holder is designated by the number 28. Generally longitudinally disposed elongated rectangular openings 29 and 31 are formed in the front and back of gripping portion 16 of the body through which a knurled dial 30 protrudes. This knurled dial is associated with the take-up spool of the device as will be explained below.

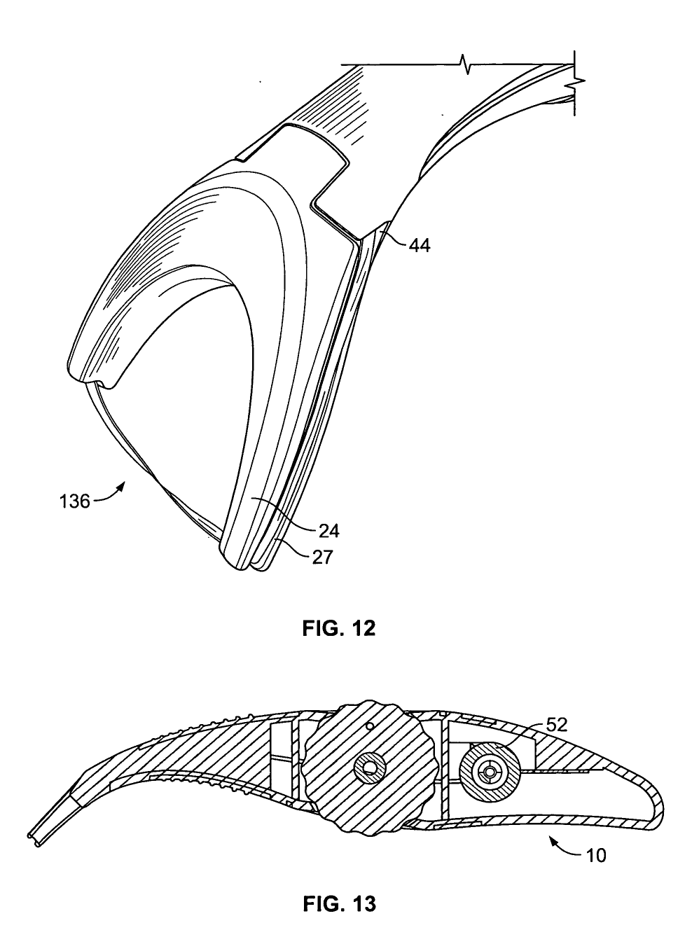

Neck 18 of the floss holder includes outgoing floss channel 42 located just below the bottom outer edge of tine 24 and an ingoing floss channel 44 located just below the bottom outer edge of tine 22. Ingoing floss channel 44 may be best seen in the enlarged view of the fork of the floss holder of FIG. 12. Additionally, slots 25 and 27 are formed along the outer edges of tines 22 and 24 to maintain the floss in place along the outer edges of the tines as fresh floss is moved from outgoing floss channel 42 across tines 22 and 24 and spent floss moves back into the device through ingoing floss channel 44.

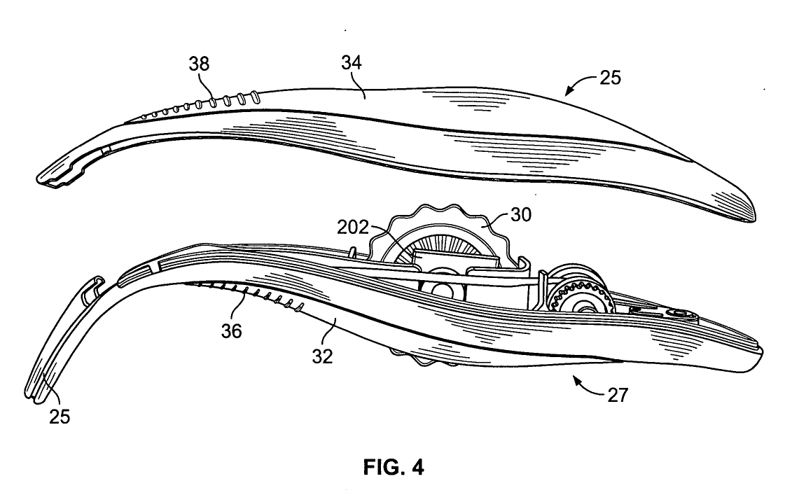

The body of floss holder 10 is made of a rigid material such as a hard plastic like ABS or polypropylene that can be easily molded to the illustrated shape. Among these polypropylene is currently preferred. The floss holder is preferably made in two parts (FIG. 4), a cover 25 and a bottom 27, joined by a locking tab at 18 and a screw (not shown). It is preferred that the outside of the cover and the bottom include respective elastomeric gripping sections 32 and 34 formed into the surface of the gripping portion of the holder encircling openings 29 and 31. These sections may be made, for example, from thermoplastic elastomers. If a thermoplastic elastomer is used, styrene ethylbutylene styrene (SEBS) is currently preferred. The elastomeric sections may extend into the neck 18 of the floss holder as shown. An arrow 40 may be formed in elastomeric section 32 as shown to indicate the direction in which knurled dial is intended to be moved in order to advance floss in the device. A like arrow (not shown) may also be formed in elastomeric section 34. Additionally, a gripping texture, provided for example by a series of laterally disposed upstanding ribs 36 and 38, may be formed in the distal ends 39 and 41 of the elastomeric sections as shown.

Floss holder 10 is intended to be grasped by wrapping the user's fingers around gripping portion 16 so that the user's thumb may easily contact knurled dial 30 at either or both of the front and the back of the device when it is desired to advance fresh floss across tines 22 and 24 or to take up slack in the floss, as will be described below. Once fresh floss is in position as required, the user may if desired shift his or her forefinger and thumb to grasp ribs 36 and 38 to facilitate the manipulation of the floss holder as the floss is moved between the user's teeth in the appropriate flossing motion.

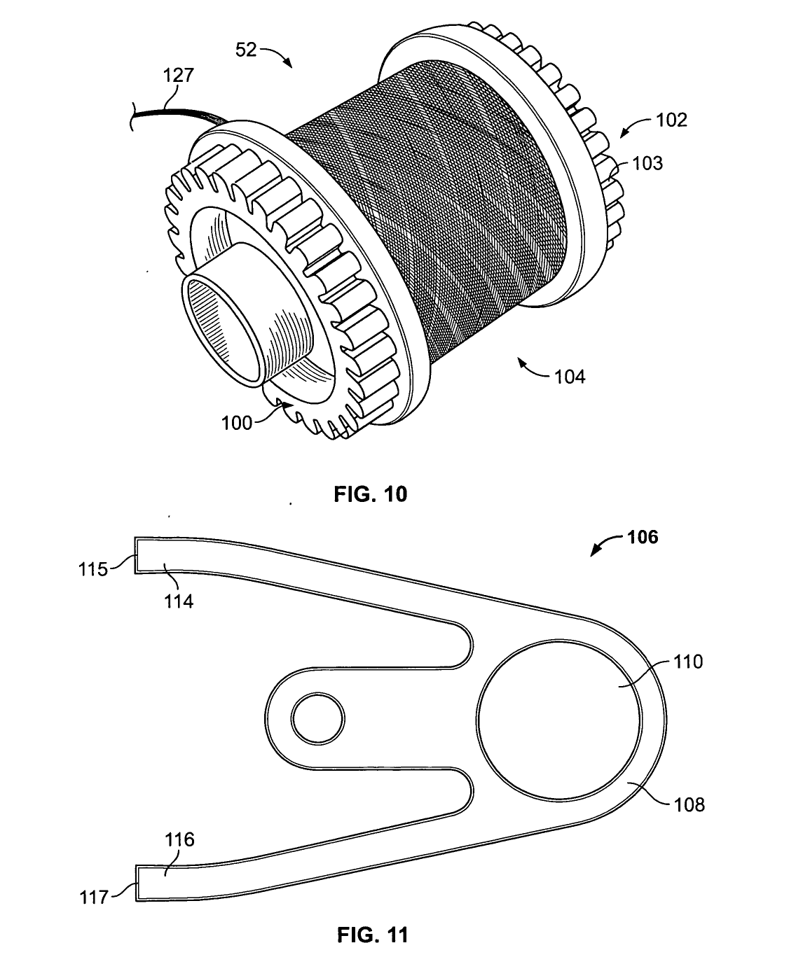

The floss control mechanism 50 of floss holder 10 disposed within the interior 51 of the device as illustrated in FIGS. 4, 5A, 5B and 13. The floss control mechanism includes a supply reel 52 (see also FIG. 10) for holding fresh, unused floss and a take-up reel 54 for holding used or spent floss mounted for rotary movement about their respective lateral axes 56 and 58. The supply and take-up reels include respective cylindrical bearing surfaces or pins 60/62 and 64/66, that project laterally from opposite sides of the reels. These pins are located, as shown, in corresponding apertures 68/70 and 72/74.

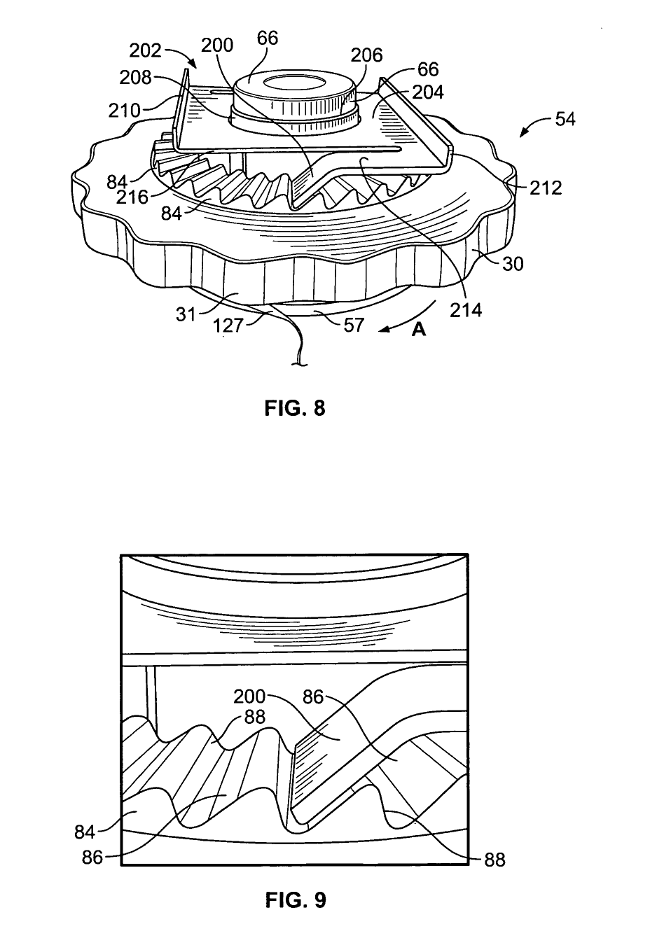

Take-up reel 54 includes an annular take-up spool section 90 having a side plate 57 and a knurled dial 30. The knurled dial is of a diameter large enough to ensure that it protrudes from openings 29 and 31 in the gripping portion of the device, as described above in connection with FIGS. 1-3. Also, the protuberances or knurls 31 (FIG. 8) facilitate rotation of the knurled dial by the user's thumb and forefinger when desired. Finally, ratchet wheel 80 is affixed to face 82 of knurled dial 30 and thereby comprises a component of the take-up reel. Thus, bearing surfaces 60 and 62, annular take-up spool section 90, side plate 57, knurled dial 30 and ratchet wheel 80 are centered on axis 58 and make up take-up reel 54.

Ratchet wheel 80 has a series of ratchet teeth 84 (FIGS. 8 and 9) each with a ramp portion 86 and a generally radially disposed descending portion 88. Ratcheting action is achieved through the cooperation of ratchet teeth 84 and a pawl 200. A resilient pawl 200 is formed in a first spring plate 202 mounted in the floss holder adjacent the ratchet teeth, as illustrated, for example, in FIG. 4. Spring plate 202 thus includes a generally flat base 204 having a circular aperture 206 with an upstanding lip 208. The aperture and lip receive pin 66 of the take-up reel snugly, but with enough space to permit unimpeded rotation of the take-up reel. If desired, an appropriate lubricant may be applied at the interface of the pin and the inner surface of the lip. Spring plate 202 further includes upstanding walls 210 and 212, which rest respectively against the inside surface of cover 25 and bottom 27 of the floss holder which together lock the spring plate in place in the fully assembled floss holder. A spring finger 214 is formed along the edge 216 of the spring plate extending beyond the center of aperture 206. Spring finger 214 includes a distal portion or pawl 200 which is bent at an angle to the plane of the spring plate generally corresponding to the angle of ramp portion 86, as seen in FIG. 8. Spring finger 214 is formed with sufficient material at its base, taking the thickness and spring characteristics of the metal from which the spring plate is made, to ensure that the finger has sufficient flexibility and appropriate springback characteristics to ensure continuous reliable performance of pawl 200 over time. Currently it is preferred that 0.010 to 0.015 stainless spring steel be used. Thus, pawl 200 rests against ramp portion 86 of ratchet wheel 80 but flexes to permit the ratchet wheel and hence the take-up reel to turn in direction A (counterclockwise) as pawl 200 rides up along the ramp portions 86 of succeeding ratchet teeth 84 and presses back into descending portions 88 of the ratchet teeth. Pawl 200 thus permits rotation of the take-up wheel in direction A (clockwise in FIG. 8) while preventing the take-up reel from turning in the opposite (counterclockwise) direction since the distal end 218 of the pawl abuts descending portion 88 of the next ratchet tooth when movement in the counterclockwise direction is attempted and will not flex or move out of the way.

Although floss may be attached to the take-up reel in any desired fashion, one way in which this can be done is by forming a hole in knurled dial 30 as shown, passing the end of the floss through the hole, forming a knot in the end of the floss which prevents the floss from being pulled back through the hole and then advancing the take-up reel in direction A to wind the floss on spool 90. Another way to attach the floss would be to form a narrow space between parts of the take-up reel and to force the end of the floss into that space thereby retaining it by friction.

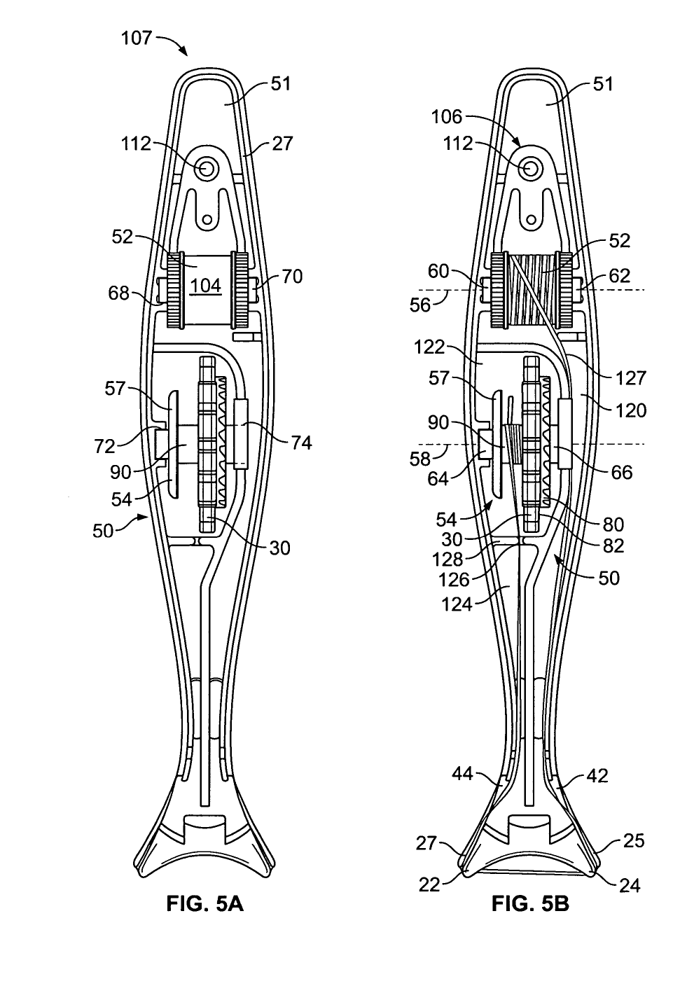

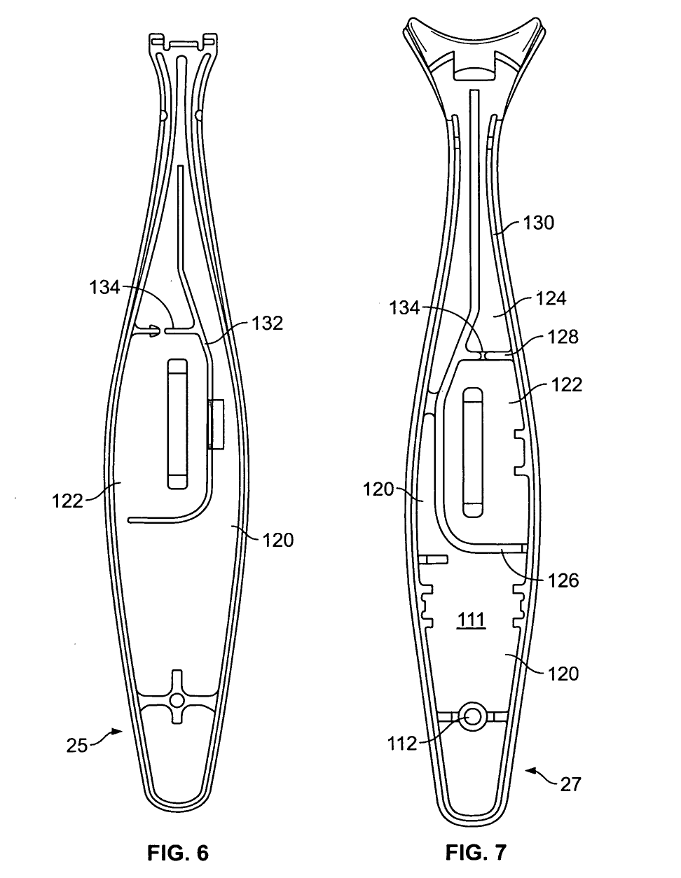

Turning now to FIGS. 5A, 5B and 10, supply reel 52 is shown comprising a pair of toothed wheels 100 and 102 disposed on opposite sides of spool 104 of the supply reel. (A single toothed wheel could, of course, be used.) Spool 104 is pre-wound with an appropriate supply of floss 127 before the device is assembled. In one embodiment, up to 12 yards of floss may be pre-wound onto spool 104.

A second spring plate or metering member 106 is provided in the proximal end 107 of the interior of bottom 27 of the floss holder. This metering member is made of an appropriate resilient material and includes a base portion 108 having an aperture 110, which is located on a pin 112 molded into the bottom surface 111 of the handle. The metering member is of a wishbone configuration and includes a pair of resilient arms 114 and 116, which engage toothed wheels 100 and 102 symmetrically across the supply reel to resist movement of the supply reel as floss is drawn from it when the take-up wheel is rotated. Indeed, when the reel is at rest the distal ends 115 and 117 of the arms will sit in the grooves 103 between adjacent toothed wheels to produce a “lock” effect in the form of increased resistance to movement from the rest position.

Metering member 106 should be made of a material having a resilience that will resist turning under the forces to which it is subjected when the exposed floss portion is being used in flossing but will allow the tooth wheels and hence reel 52 to rotate the minimum necessary distance and without overshooting dictated by the pulling forces to which the floss is subjected when knurled dial 30 is rotated in a clockwise direction to advance or draw clean floss onto tines 22 and 24. The resistance provided by the cooperating resilient arms of the metering member and the toothed wheels also will permit limited floss movement when excessive force is applied during flossing to minimize stretching of the floss and to prevent damage to the floss or the floss holder. Currently, the metering member is made of stainless spring steel between 0.012 to 0.020 inches in thickness.

Sufficient friction is provided by the engagement of the metering member with the toothed wheels to maintain tension in the floss running from the supply reel, in slots 25 and 27, across the fork, and to the take-up reel, to ensure that the exposed floss portion will remain taut. This friction thus also maintains the exposed floss portion in the desired location during use and ensures that it is be available to be used effectively in flossing the teeth without causing undesirable sag in the exposed floss portion. However, in the event that the floss stretches during use or sufficient force is applied to overcome the friction provided by the engagement of the metering member with the toothed wheels, the slack can be taken up by simply rotating the take-up spool, preferably as the floss holder is being used. Additionally, as the toothed wheels move against the metering member an audible clicking sound is produced that signals the advance of clean floss within the floss holder.

The interior 51 of the floss holder includes generally isolated compartments, namely a fresh floss supply compartment 120, a spent floss holding compartment 122, and a spent floss return compartment 124. These compartments are defined by upstanding walls 126 and 128 and lip 130 in floss holder bottom 27 and corresponding upstanding walls 132 and 134 in floss holder cover 25. Walls 126/128 and 132/134 abut and lip 130 rests against the inside of the cover when the cover and bottom are assembled. Walled compartments 120, 122 and 124 respectively isolate fresh outgoing floss (compartment 120) from incoming spent floss (compartments 122 and 124), as will be explained in more detail below. This isolation of the fresh and spent floss minimizes cross-contamination between the fresh outgoing floss and the incoming spent floss.

When floss holder 10 is ready to be assembled, floss 127 will be threaded as shown in FIG. 5B from supply reel 52 up through compartment 120 and outgoing floss channel 42, along slot 25, across tines 22 and 24 back down through slot 27 through ingoing floss channel 44, through compartment 124 across floss passage 134 in wall 128, into compartment 122 and onto the take-up spool. Here the floss is attached, for example, by passing the end of the floss through a hole in the wall of the take-up spool and forming an appropriately-sized knot (not shown) to resist removal of the floss or by forcing the end of the floss into a tight-fitting slot where it will be held by friction. The cover and bottom of the floss holder are then fit together (FIG. 4) and the two parts are fixed together as discussed earlier.

Once the floss holder is assembled and ready for use, the user grasps gripping portion 16 and orients fork 20 with the exposed floss portion 136 in the interstices between the user's teeth. The floss holder is then manipulated to move the exposed floss portion as appropriate, to thereby clean the spaces between the teeth and exercise the gums as recommended for proper dental hygiene.

When the exposed floss portion is spent, the user presses their thumb and/or forefinger against the protruding portion of knurled dial 30 and applies sufficient rotary force to advance the take-up reel in a clockwise direction as shown by arrow A in FIG. 5 against the resistance presented at the supply reel. This direction of movement is permitted by pawl 200, which rides along the ramps of the teeth of ratchet wheel 80 as the take-up wheel is rotated. Thus, as the take-up wheel is rotated, floss is drawn from the supply reel causing the supply reel to rotate, as arms 114 and 116 of metering member 106 ride along toothed wheels 100 and 102. The tension applied by the user in rotating the take-up reel combined with the locking action of pawl 200 and ratchet teeth 84 and the resistance provided by toothed wheels 100 and 102 and metering member 106 prevents unintended rotation of the reels and maintains the desired tension in the exposed floss portion as it is used in flossing.

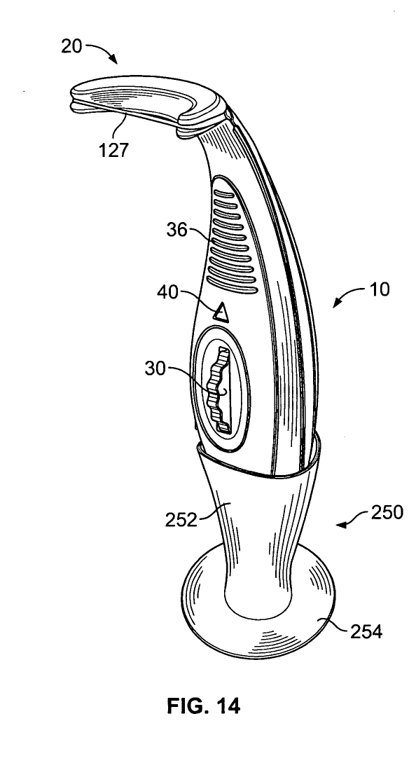

Finally, a receptacle 250 may be provided for the floss holder as illustrated in FIG. 14. Receptacle 250 includes an upwardly directed hollow portion 252 configured to receive the tapered end 14 of the floss holder. Hollow portion 252 of the receptacle is affixed to a generally planar base 254. Receptacle 250 thus makes it possible to conveniently store the floss holder between uses by placing receptacle 250 on a generally horizontal surface such as a shelf and placing the tapered end of the floss holder in receiving portion 252. When needed, the floss holder can be simply removed from the receptacle, used, and then returned for storage until the next use. Storage in this manner facilitates drying of exposed floss in the floss holder.

It should be understood that the form of the invention as shown and described above is to be taken as a preferred example, and that variations in the shape, size, arrangement and operation of the floss holder may be made without departing from the spirit or scope of the invention.

Although preferred embodiments of the present invention has been described foregoing Detailed Description and illustrated in the accompanying drawings, it should be understood that the invention is not limited to the embodiments disclosed, but is capable of numerous rearrangements, modifications, and substitutions of parts and elements without departing from the spirit of the invention. Accordingly, the present invention is intended to encompass such rearrangements, modifications, and substitutions as fall within the scope of the appended claims.

What is claimed is:

1. A manual advance floss holder comprising:
a body with a fork located at its distal end, the fork including spaced apart distally directed tines;
a floss control mechanism located within the body,
the floss control mechanism including a supply reel for holding fresh floss and a take-up reel for holding spent floss;
compartments within the body for isolating fresh and spent floss; and
means for advancing floss from the supply reel across the space between the tines of the fork for use in flossing and means for withdrawing spent floss from the space between the tines of the fork onto the take-up reel.

2. The manual advance floss holder of claim 1 in which the body includes a bulbous gripping portion.

3. The manual advance floss holder of claim 1 in which the body includes elastomeric gripping sections on its surface.

4. The manual advance floss holder of claim 3 in which the elastomeric gripping sections include upstanding ribs.

5. The manual advance floss holder of claim 1 in which outgoing and ingoing floss channels are positioned below the bottom outer edge of each of the tines and slots are located along the outer edges of the tines to maintain the floss in place as it is moved between the tines.

6. The manual advance floss holder of claim 1 in which:
the take-up reel includes an annular take-up spool section and a dial for rotating the take-up wheel; and
the body includes an opening,
the dial being of a diameter large enough to protrude from the opening.

7. The manual advance floss holder of claim 6 in which the body includes a front and a back, longitudinally disposed elongated openings disposed in the front and the back, and the dial protrudes through both openings.

8. The manual advance floss holder of claim 6 in which the outer edge of the dial is knurled.

9. The manual advance floss holder of claim 1 in which:
the take-up reel includes a ratchet wheel having a series of ratchet teeth; and
the floss control mechanism includes a resilient pawl engaging the ratchet teeth to permit the take-up reel to rotate in a first direction while preventing rotation of the take-up reel in the opposite direction.

10. The manual advance floss holder of claim 9 in which the resilient pawl projects from a spring plate positioned adjacent the ratchet wheel.

11. The manual advance floss holder of claim 10 in which the take-up reel is mounted for rotation on pins projecting in opposite directions along the axis of the take-up reel, the spring plate includes an aperture, and the spring plate is mounted in the floss holder with one of the pins passing through the aperture.

12. The manual advance floss holder of claim 1 in which:
the supply reel is provided with a toothed wheel centered on the central axis of the supply reel; and
a metering member with resilient arms engaging the tooth wheel is provided to produce resistance against rotation of the supply reel thereby permitting fresh floss to be drawn from the supply reel when desired, while maintaining tension in the floss.

13. The manual advance floss holder of claim 1 in which the floss holder includes a bottom and a cover and in which the compartments are defined by corresponding upstanding walls in the bottom and cover of the floss holder.

14. The manual advance floss holder of claim 1 including a supply compartment, a spent floss holding compartment, and a spent floss return compartment.

15. The manual advance floss holder of claim 14 in which a floss passage is provided between the spent floss holding compartment and the spent floss return compartment.

16. The manual advance floss holder of claim 1 including a receptacle for storing the floss holder in an upright position with the distally directed tines exposed when the floss holder is not in use.

17. A manual advance floss holder comprising:
a body with a fork located at its distal end, the fork including spaced apart distally directed tines,
the body including a bulbous gripping portion and elastomeric gripping sections on its surface;
a floss control mechanism located within the body,
the floss control mechanism including a supply reel for holding fresh floss and a take-up reel for holding spent floss;
compartments within the body for isolating fresh and spent floss; and
means for advancing floss from the supply reel across the space between the tines of the fork for use in flossing and means for withdrawing spent floss from the space between the tines of the fork onto the take-up reel.

18. The manual advance floss holder of claim 17 in which the elastomeric gripping sections include upstanding ribs.

19. A manual advance floss holder comprising:
a body with a fork located at its distal end, the fork including spaced apart distally directed tines; and
a floss control mechanism located within the body for advancing floss across the tines,
the floss control mechanism including a supply reel for holding fresh floss for movement across the tines and a take-up reel for collecting and holding spent floss,
the take-up reel including a dial protruding from the body for rotating the take-up reel, a ratchet wheel with a series of ratchet teeth and a resilient pawl engaging the ratchet teeth to permit the take-up reel to rotate in a first direction while preventing rotation of the take-up reel in the opposite direction, and
the supply reel containing fresh floss and including a toothed wheel centered on the central axis of the supply reel, a metering member with a resilient arm engaging the tooth wheel to produce resistance against rotation of the supply reel, and an audible signal when floss is advanced within the floss holder.

20. The manual advance floss holder of claim 19 in which grooves are provided between the teeth of the toothed wheel and the distal end of the resilient arm sits in a groove when the reel is at rest to provide increased resistance to movement from the rest position.
